(19) United States
(12) Patent Application Publication
(10) Pub. No.: US 2014/0096934 A1
(43) Pub. Date: Apr. 10, 2014

(54) MODULAR HEAT SINK FOR LED LUMINAIRE

(71) Applicant: OSRAM GMBH, München (DE)

(72) Inventors: Huijun Xiong, Shenzhen Guangdong (CN); You Chen, Shenzhen Guangdong (CN); Hao Li, Shenzhen Guangdong (CN); Xiaomian Chen, Shenzhen Guangdong (CN)

(73) Assignee: OSRAM GMBH, Muenchen (DE)

(21) Appl. No.: 14/119,449

(22) PCT Filed: May 3, 2012
(86) PCT No.: PCT/EP2012/058152

§ 371 Date: Nov. 22, 2013

(30) Foreign Application Priority Data
May 24, 2011 (DE) 201110139652.X

(51) Int. Cl. F21V 29/00

(52) U.S. Cl. CPC F21V 29/2225
USPC 165/86

(57) ABSTRACT

A modular heat sink for LED luminaire may include at least two modular heat sink units, which are joined together in thermal communication with each other for use in the LED luminaire, such that the illuminating angle of the LED luminaire can be adjusted within a range of 0° to 180°.

### RELATED APPLICATIONS

This application is a national stage entry according to 35 U.S.C. §371 of PCT application No.: PCT/EP2012/058152 filed on May 3, 2012, which claims priority from Chinese application No. 201110139652.X filed on May 24, 2011.

### TECHNICAL FIELD

Various embodiments relate to a modular heat sink, in particular to a modular heat sink for LED luminaire.

### BACKGROUND

Today LEDs have had increasing popularity and application in various aspects in production and life due to its ability to be lightened with less electric power. However, although the LED has an advantage of low electric consumption, a disadvantage that the using temperature of the LED is too high in use does exist. It is well know that, in LED illumination, 85% of the power used to activate the LED will be transformed into heat and only 15% thereof can be transformed into luminous energy, due to constraints from present chip technology. The LED is extremely sensitive to temperature. Therefore, the temperature of the LED directly influences lifetime and optical performance of the LED. The higher the temperature is, the shorter the lifetime of the LED will be and also the lower the light output is. Thus, the design of a heat dissipating structure is of vital importance in LED luminaire design. Such a heat dissipating structure is called a heat sink. Heat dissipating performance of the heat sink is directly proportional to heat dissipating area thereof.

FIG. 1 shows a prior art LED luminaire with a heat sink. The heat sink is in a cylindrical form and is made by extruding process. In this case, the size in height of this heat sink is not limited. This heat sink has excellent heat dissipating performance even if it is used with a high power LED luminaire. However, the disadvantage of such a LED luminaire lies in that the illuminating angle thereof can not be adjusted. FIG. 2 shows another prior art LED luminaire with a heat sink. The illuminating angle of this LED luminaire is adjustable by ±20°. To avoid interference between the heat sink and a mount ring, this heat sink has a relatively low height, which in turn results in a small heat dissipating area. Therefore, this heat sink can only be used in a low power LED luminaire. In some application circumstances, a high power LED luminaire with adjustable illuminating angle is required, and even the adjustable range of the angle needs to be as high as 0° to 80°, so as to meet the illuminating requirements for various areas in application environments.

Further, according to market demand, the same one LED luminaire is required to be activated with different power, which needs the heat sink of the LED luminaire has excellent heat dissipating performance even under the highest power. However, this results in another problem. That is, the temperature of the LED luminaire under low power is far lower than the highest limited temperature such that the heat dissipating ability of the heat sink may not be fully utilized and thereby the cost of the production is increased.

### SUMMARY

To solve the above technical problems, various embodiments provide a modular heat sink for LED luminaire, which can be used for a high power LED luminaire while allows to adjust the illuminating angle of the LED luminaire within a range of 0° to 180°, and which is easy to manufacture.

A modular heat sink for LED luminaire is provided by the present disclosure. The modular heat sink is formed by combining or joining 2 to n (n>3) modular heat sink units together. Each one modular heat sink unit is fixed to another modular heat sink unit by way of snap engagement, screw engagement, weld or the like. A heat conducting member may be provided between the modular heat sink units, or thermal conductive medium may be coated on or adhered to the interfaces therebetween with. In the case where two modular heat sink units are provided, the modular heat sink is formed by combining or joining only the two modular heat sink units together. If another modular heat sink unit is further fixed to the two modular heat sink units as joined or combined previously, the heat sink is formed by combination of the three modular heat sink units. So on and so forth, the modular heat sink of the present disclosure may be formed by combining or joining n modular heat sink units together. Such modular heat sink unit is a radiator with small angle, which may be manufactured by way of casting, extrusion, machining and the like.

Specifically, according to the present disclosure, there provides a modular heat sink for a LED luminaire, wherein the modular heat sink includes at least two modular heat sink units, which are joined together in thermal communication with each other for use in, in particular a high power LED luminaire, such that the illuminating angle of the LED luminaire can be adjusted within a range of 0° to 180°.

In an embodiment of the present disclosure, the modular heat sink includes three modular heat sink units.

Preferably, the modular heat sink units are joined together by way of snap engagement, screw engagement, weld or the like.

In another embodiment of the present disclosure, a heat conducting member made of thermal conductive material is provided between the modular heat sink units, and the heat conducting member serves to conduct heat between the modular heat sink units and, if required, serves as a connector between the modular heat sink units.

In a yet embodiment of the present disclosure, thermal conductive medium, such as silicone grease, is coated on or adhered to the interfaces between the modular heat sink units so as to reduce thermal resistance of the interfaces.

Preferably, the modular heat sink units are made of same or different thermal conductive material including aluminum, copper, thermal conductive plastics, ceramics, and the like.

Preferably, the modular heat sink units are formed to be of same or different structure(s) and shape(s).

Preferably, the modular heat sink unit is formed to be a curved, angular hollow cylinder in shape, such that the modular heat sink constructed by the modular heat sink units is configured to have a curving angle and a length, which may allow the modular heat sink to turn out from a mount ring of the LED luminaire with a turned out angle of up to 180°, thereby achieving the adjustment of the illuminating angle of the LED luminaire within a range of 0° to 180°.

The modular heat sink units are manufactured by one or more of the processes including casting, extrusion, machining, and the like.

Compared with the prior art, the modular heat sink of the present disclosure may be formed by combining or joining various number n of modular heat sink units together according to various power requirements for the LED luminaire. Therefore, the costs of the heat sink are reduced, and the manufacturing process for the modular heat sink unit of the heat sink is simple and varied. Furthermore, the illuminating angle of the LED luminaire may be adjusted within a range of 0° to 180°.

### BRIEF DESCRIPTION OF THE DRAWINGS

The above and further objects and advantages of embodiments of the present disclosure will be further described in conjunction with specific embodiments and with reference to accompanying drawings. The present disclosure will become more apparent from reading the description below. In the drawings, same or corresponding technical features or components are indicated by same or corresponding reference signs, in which:

FIG. 1 shows a prior art LED luminaire with its illuminating angle being unadjustable;

FIG. 2 shows a prior art low power LED luminaire with its illuminating angle being adjustable within a small range;

FIG. 3 shows a modular heat sink including two modular heat sink units according to first embodiment of the present invention;

FIG. 4 shows a modular heat sink including three modular heat sink units according to second embodiment of the present disclosure; and

FIG. 5 shows a modular heat sink including n modular heat sink units according to third embodiment of the present disclosure.

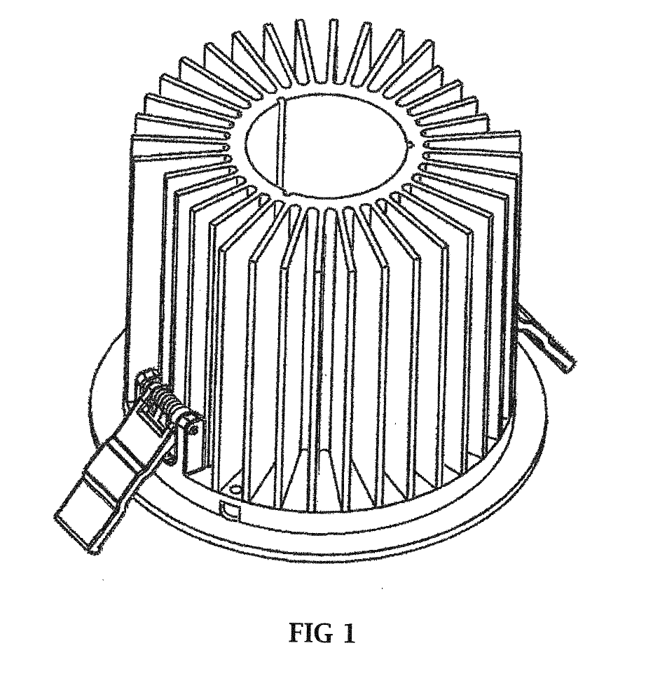

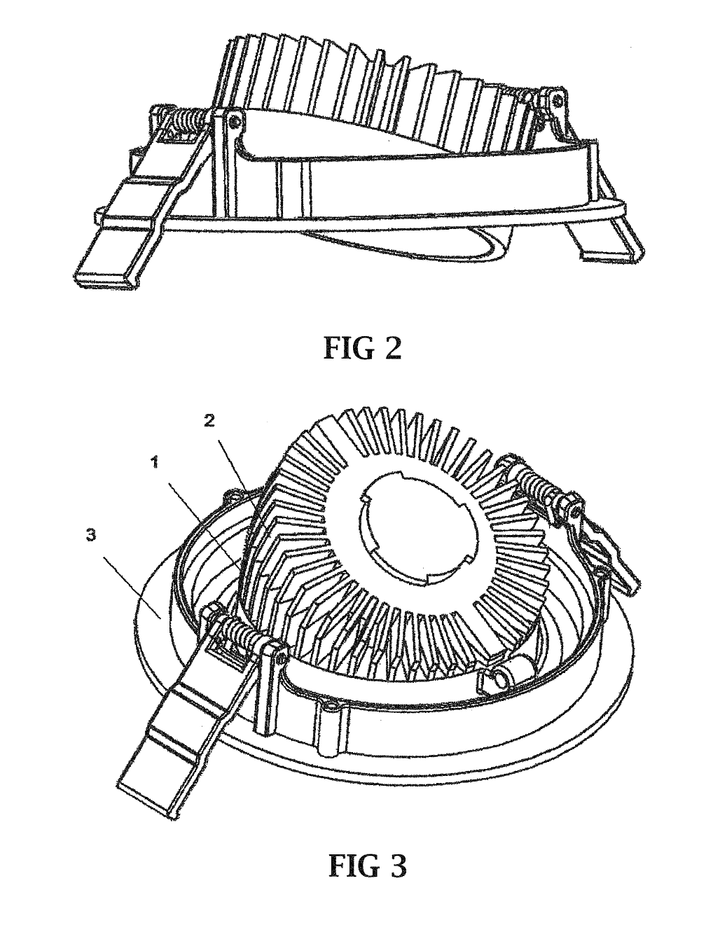

### DETAILED DESCRIPTION

Here below presents various specific embodiments of the present disclosure, which only serve to illustrate the present disclosure and should not be construed as limitation thereto.

As shown in FIG. 3 that shows a modular heat sink according to the first embodiment of the present invention, in which the heat sink consists of two modular heat sink units, i.e., a first modular heat sink unit 1 and a second modular heat sink unit 2. The second modular heat sink unit 2 is fixed to the first modular heat sink unit 1 by way of snap engagement, screw engagement, weld or the like so as to be in thermal communication with the first heat sink unit 1, such that thermal energy (heat) may be conducted from the first modular heat sink unit 1 to the second modular heat sink unit 2 and then to the outside, resulting in heat dissipating of the LED luminaire.

For better heat conducting, a heat conducting member made of thermal conductive material may be provided between the first modular heat sink unit 1 and the second modular heat sink unit 2 to facilitate heat conducting and dissipating therebetween. Also, if required, the heat conducting member may function as a connector between the first modular heat sink unit 1 and the second modular heat sink unit 2 to facilitate connection therebetween. The thermal conductive material may be aluminum, copper, thermal conductive plastics, ceramics, and the like. Alternatively, thermal conductive medium, such as silicone grease, may be coated on or adhered to the interface (joint face) between the first modular heat sink unit 1 and the second modular heat sink unit 2 to reduce interface thermal resistance and thus improve heat conducting and heat dissipating performance.

In the first embodiment of the present invention, the first modular heat sink unit 1 has the same structure as the second modular heat sink unit 2. As shown in FIGS. 3-5, the modular heat sink unit is formed to be a curved, angular hollow cylinder in shape. However, depending on practical uses, the modular heat sink unit may also be provided in different structure and shape, for example, with different curving angle and length, respectively.

In the first embodiment of the present invention, as shown in FIG. 3, the first modular heat sink unit 1 and the second modular heat sink unit 2 are made of the same thermal conductive material, which includes aluminum, copper, thermal conductive plastics, ceramics, and the like. However, depending on practical uses, the modular heat sink unit of the present invention may also be made of different thermal conductive material. For example, the first modular heat sink unit 1 is made of aluminum and the second modular heat sink unit 2 is made of copper, and so on.

As shown in FIG. 3, the modular heat sink constructed by the first modular heat sink unit 1 and the second modular heat sink unit 2 is configured to have a curving angle and a length, which may cause the modular heat sink to be turned out from a mount ring 3 of the LED luminaire, and the turned out angle may be up to 180°. Therefore, it is possible for the modular heat sink of the present invention to achieve adjusting of the illuminating angle of the LED luminaire within the range of 0° to 180°.

The first modular heat sink unit 1 and the second modular heat sink unit 2 may be manufactured by one or more of the processes comprising casting, extrusion, machining, and the like. Since they are both a radiator with a small angle, they are easy to be manufactured using the above mentioned processes.

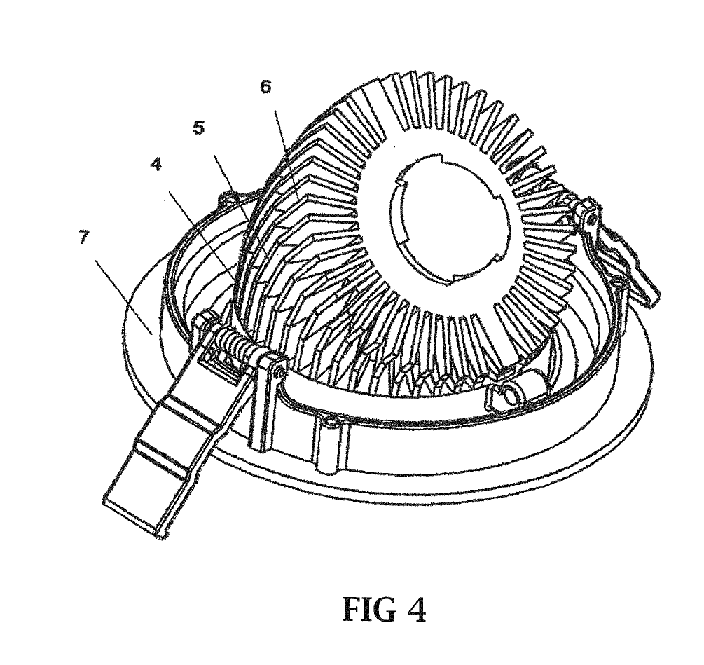

As shown in FIG. 4 that shows a modular heat sink according to the second embodiment of the present invention, in which the heat sink consists of three modular heat sink units, i.e., a modular heat sink unit 4, a modular heat sink unit 5 and a modular heat sink unit 6. In this modular heat sink, the modular heat sink unit 5 is fixed to the modular heat sink unit 4 by way of snap engagement, screw engagement, weld or the like, and also the modular heat sink unit 6 is fixed to the modular heat sink unit 5 by way of snap engagement, screw engagement, weld or the like, such that thermal energy (heat) may be conducted between the modular heat sink units 4, 5, 6 and then dissipated to the outside, thereby implementing the purpose of heat dissipating for the LED luminaire.

Similar to the first embodiment, in the second embodiment heat conducting members made of thermal conductive material may be provided between the modular heat sink units 4, 5, 6 to facilitate heat conducting and dissipating therebetween. Also, where required, the heat conducting members may function as connectors between the modular heat sink units 4, 5, 6. Alternatively, the interfaces between the modular heat sink units 4, 5, 6 may be coated or adhered with thermal conductive medium, such as silicone grease, to reduce interface thermal resistance and thus improve heat conducting and heat dissipating performance.

In the second embodiment, the modular heat sink units 4, 5, 6 have the same structure. As shown in FIG. 4, the modular heat sink units are formed to be a curved, angular hollow cylinder in shape. However, depending on practical uses, the modular heat sink units may also be provided in different structures and shapes, for example, with their respective curving angle and length being different from each other.

In the second embodiment of the present invention, as shown in FIG. 4, the modular heat sink units 4, 5, 6 are made of the same thermal conductive material, which includes aluminum, copper, thermal conductive plastics, ceramics, and the like. However, depending on practical uses, the modular heat sink units of the present invention may also be made of different thermal conductive material. For example, the modular heat sink unit 4 is made of aluminum and the modular heat sink units 5, 6 are made of copper, and so on.

As shown in FIG. 4, the curving angle and the length of the modular heat sink constructed by the modular heat sink units 4, 5, 6 are configured to allow the modular heat sink to be turn out from a mount ring 7 of the LED luminaire, and the turned out angle may be up to 180°. Therefore, it is possible for the modular heat sink of the present invention to achieve adjusting of the illuminating angle of the LED luminaire within the range of 0° to 180°.

Correspondingly, the modular heat sink units 4, 5, 6 may be manufactured by one or more of the processes comprising casting, extrusion, machining, and the like.

The modular heat sink of the second embodiment of the present invention may be used in a LED luminaire with higher power than that as in the first embodiment.

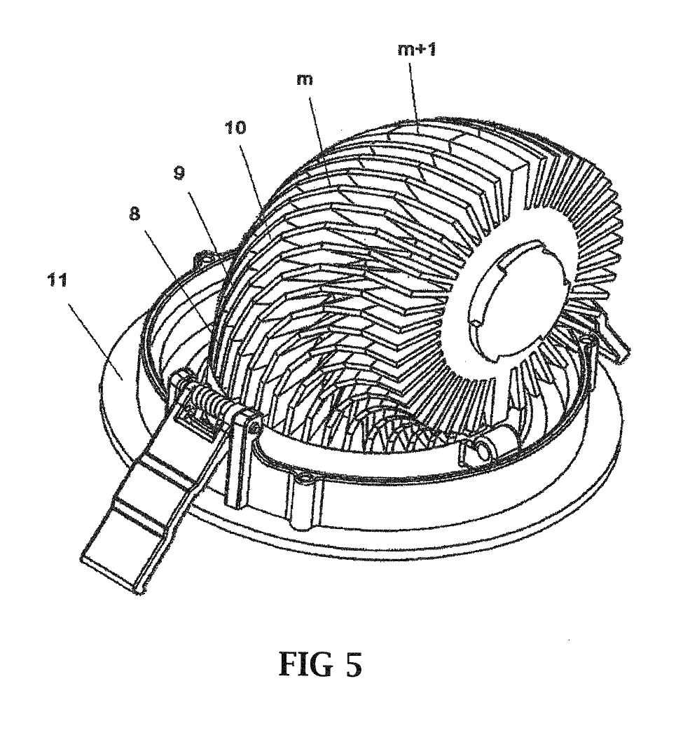

As shown in FIG. 5 that shows a modular heat sink of the third embodiment of the present invention, in which the modular heat sink consists of n (n>3) modular heat sink units, i.e., a module heat sink unit 8, a module heat sink unit 9, a module heat sink unit 10, a module heat sink unit m and a module heat sink unit m+1 . . . a module heat sink unit n. Wherein, the modular heat sink unit 9 is fixed to the modular heat sink unit 8 by way of snap engagement, screw engagement, weld or the like, and also the modular heat sink unit 10 is fixed to the modular heat sink unit 9 by way of snap engagement, screw engagement, weld or the like, and so on, the module m is fixed to the module 10 by way of snap engagement, screw engagement, weld or the like, and the module m+1 is fixed to the module m by way of snap engagement, screw engagement, weld or the like, such that thermal energy may be conducted between the modular heat sink units 8, 9, 10 . . . m+1 . . . n and then dissipated to the outside, thereby implementing the heat dissipating of the LED luminaire.

Similar to the first and the second embodiments, heat conducting members made of thermal conductive material may be provided, in the third embodiment, between the modular heat sink units 8, 9, 10 . . . m+1 . . . n to facilitate heat conducting and dissipating therebetween. Also, where required, the heat conducting members may serve as connectors between the modular heat sink units 8, 9, 10 . . . m+1 . . . n. Alternatively, thermal conductive medium, such as silicone grease, may be coated on or adhered to the interfaces (joint faces) between the modular heat sink units 8, 9, 10 . . . m+1 . . . n, so as to reduce interface thermal resistance and thus improve heat conducting and heat dissipating performance.

In the third embodiment, the modular heat sink units 8, 9, 10 . . . m+1 . . . n have the same structure. As shown in FIG. 5, the modular heat sink units are formed to be a curved, angular hollow cylinder in shape. However, depending on practical uses, the modular heat sink units may also be provided in different structures and shapes, for example, with their respective curving angle and length differing from each other.

In the third embodiment of the present invention, as shown in FIG. 5, the modular heat sink units 8, 9, 10 . . . m+1 . . . n are made of the same thermal conductive material, which includes aluminum, copper, thermal conductive plastics, ceramics, and the like. However, depending on practical uses, the modular heat sink units of the present invention may also be made of different thermal conductive material. For example, the modular heat sink unit 8 is made of aluminum and the modular heat sink units 9, 10 . . . are made of copper, and so on.

As shown in FIG. 5, the modular heat sink constructed by the modular heat sink units 8, 9, 10 . . . m+1 . . . n is configured to have a curving angle and a length, which allow the modular heat sink to turn out from the mount ring 11 of the LED luminaire, and the turned out angle may be up to 180°. Therefore, it is possible for the modular heat sink of the present invention to implement adjustment of the illuminating angle for the LED luminaire within the range of 0° to 180°.

Similarly, the modular heat sink units 8, 9, 10 . . . m+1 . . . n may be manufactured by one or more of the processes as casting, extrusion, machining and the like.

The modular heat sink of the third embodiment of the present invention may be used in a LED luminaire with much higher power than that as in the first and the second embodiments.

Although the above preferred embodiments of the present disclosure has been illustrated and described, it should be understood by an ordinary person skilled in the art various modifications, changes and combinations can be made to the present invention according to design requirements and other conditions without departing from the spirit and scope of protection of the claims of the present disclosure.

1. A modular heat sink for LED luminaire comprising at least two modular heat sink units, which are joined together in thermal communication with each other for use in the LED luminaire, such that the illuminating angle of the LED luminaire can be adjusted within a range of 0° to 180°.

2. The modular heat sink for LED luminaire according to claim 1, wherein said modular heat sink comprises three modular heat sink units.

3. The modular heat sink for LED luminaire according to claim 1, wherein said modular heat sink units are jointed together by way of snap engagement, screw engagement, or weld.

4. The modular heat sink for LED luminaire according to claim 1, wherein a heat conducting member is provided between said modular heat sink units, and said heat conducting member serves to conduct heat between said modular heat sink units and, if required, functions as a connector between said modular heat sink units.

5. The modular heat sink for LED luminaire according to claim 1, wherein thermal conductive medium, such as silicone grease, is coated on or adhered to the interface between the modular heat sink units so as to reduce interface thermal resistance.

6. The modular heat sink for LED luminaire according to claim 1, wherein said modular heat sink units are made of same or different thermal conductive material comprising aluminum, copper, thermal conductive plastics, and ceramics.

7. The modular heat sink for LED luminaire according to claim 1, wherein said modular heat sink units are formed to be of same or different structure(s) and shape(s).

8. The modular heat sink for LED luminaire according to claim 7, wherein said modular heat sink units are formed to be a curved, angular hollow cylinder in shape, such that the modular heat sink constructed by the modular heat sink units is configured to have a curving angle and a length, which allow the modular heat sink to turn out from a mount ring of the LED luminaire with a turned out angle of up to 180°, thereby implementing adjustment of the illuminating angle for the LED luminaire within a range of 0° to 180°.

9. The modular heat sink for LED luminaire according to claim 1, wherein said modular heat sink units are manufactured by one or more of the processes comprising casting, extrusion, and machining.
